(19) United States
(12) Patent Application Publication
(10) Pub. No.: US 2020/0167720 A1
(43) Pub. Date: May 28, 2020

(54) METHOD OF SHIPPING WITH NON-PRINTED LABELS

(71) Applicant: Panasonic Automotive Systems Company Of America, Division of Panasonic Corporation Of North America, Peachtree City, GA (US)

(72) Inventor: JOHN AVERY, NEWNAN, GA (US)

(21) Appl. No.: 16/683,681

(22) Filed: Nov. 14, 2019

Related U.S. Application Data
(60) Provisional application No. 62/771,866, filed on Nov. 27, 2018.

(51) Int. Cl. G06Q 10/08

(52) U.S. Cl. CPC G06Q 10/087

(57) ABSTRACT

A package shipping arrangement includes a computer system having a processing block receiving a first digital representation, captured by a camera, of a hand drawn mark on a package to be shipped. The processing block receives a desired destination address of the package, and compares the first digital representation of the mark to other digital representations of marks stored in memory. The processing block determines whether the first digital representation of the mark is different from all the other digital representations of marks. In response to determining that the first digital representation of the mark is different from all the other digital representations of marks, the processing block stores the first digital representation of the mark in the memory block in association with the desired destination address of the package.

### CROSS-REFERENCED TO RELATED APPLICATIONS

This application claims benefit of U.S. Provisional Application No. 62/771,866 filed on Nov. 27,2018, the disclosure of which is hereby incorporated by reference in its entirety for all purposes.

### FIELD OF THE INVENTION

The disclosure relates to identifying an address to which a package is to be shipped.

### BACKGROUND OF THE INVENTION

Currently, customers desiring to ship a package are required to print custom labels, typically with a barcode indicating the shipping information. The requirement for a printer and custom printed labels adds friction to the shipping process.

### SUMMARY

The present invention may enable the shipping of packages without the need for any printed labels by placing a unique hand drawn mark on the box. The customer then captures a photograph of the mark with a smartphone using the shipping company's smartphone application which associates the mark with a shipping record that the customer enters into the application or selects in the application. When the shipping company picks up the package for delivery, the employee scans the mark on the box. Then the shipping company's computer system matches the scanned mark with the photographed mark that is associated with the shipping record that was created when the mark was photographed and uploaded into the application. The shipping company can then print a label including the destination address from the shipping record and adhere the label to the package. Alternatively, the shipping company can scan the mark at each of the shipping company's stations along the delivery route in order to determine the destination address and thereby keep the package traveling toward the destination address.

The invention may make it possible for anyone to draw or otherwise create a unique identifying mark on the package and associate this drawing/mark with the shipping information in the cloud. When the delivery person comes to pick up the package, he/she can scan the hand-drawn mark, and the shipping company's computer system matches the mark with the associated shipping record.

In one embodiment, the invention comprises a package shipping arrangement including a computer system having a processing block and a memory block. The processing block receives a first digital representation of a hand drawn mark on a package to be shipped, wherein the first digital representation of the mark had been captured by a camera. The processing block receives an identification of a desired destination address of the package. The processing block compares the first digital representation of the mark to other digital representations of marks stored in the memory block. The processing block determines whether the first digital representation of the mark is different from all the other digital representations of marks. In response to determining that the first digital representation of the mark is different from all the other digital representations of marks, the processing block stores the first digital representation of the mark in the memory block in association with the desired destination address of the package. A camera captures an image of the hand drawn mark on the package to be shipped and transmits a second digital representation of the mark based on the captured image to the processing block. The processing block uses the second digital representation of the mark to retrieve from the memory block the desired destination address of the package that has been stored in association with the first digital representation of the mark.

In another embodiment, the invention comprises a package shipping method including receiving a first digital representation of a hand drawn mark on a package to be shipped. An identification of a desired destination address of the package is received. The first digital representation of the mark is compared to other digital representations of marks stored in a memory device. It is determined whether the first digital representation of the mark is different from all the other digital representations of marks. In response to determining that the first digital representation of the mark is different from all the other digital representations of marks, the first digital representation of the mark is stored in the memory device in association with the desired destination address of the package.

In yet another embodiment, the invention comprises a package shipping method including receiving a first digital representation of a hand drawn mark on a package to be shipped. An identification of a desired destination address of the package is received. The first digital representation of the mark is stored in the memory device in association with the desired destination address of the package. A second digital representation is captured of the hand drawn mark on the package to be shipped. The second digital representation of the hand drawn mark is used to retrieve from the memory device the desired destination address of the package.

An advantage of the present invention is that it may eliminate the need for a printer or labels when preparing boxes for shipping by common shipping carriers (such as UPS, FedEx, USPS).

### BRIEF DESCRIPTION OF THE DRAWINGS

A better understanding of the present invention will be had upon reference to the following description in conjunction with the accompanying drawings.

FIG. 1 is a perspective view of one embodiment of a package having a hand drawn mark thereon according to one embodiment of the present invention.

FIG. 2 is a perspective view of a customer using a smartphone to capture an image of the mark of FIG. 1 according to one embodiment of the present invention.

FIG. 3 is a block diagram of one embodiment of a package shipping arrangement of the present invention.

FIG. 4 is a flow chart of one embodiment of a package shipping method of the present invention.

### DETAILED DESCRIPTION OF THE PREFERRED EMBODIMENTS

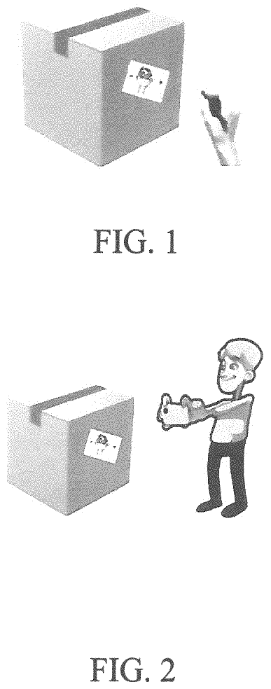

FIG. 1 illustrates one embodiment of a package that is to be shipped to another location by a shipping organization. The package may be, for example, a cardboard box that contains some goods and that has been sealed closed, such as by packaging tape. A customer who wants to ship the package has drawn by hand a mark in the form of a drawing of a cartoon-like stick figure on a sheet of paper or sticker, and the sheet of paper or sticker has been attached to the package of the present invention, such as by being adhered to or taped to the package. However, the mark may be hand drawn either directly on the package or on a piece of paper that then gets attached to the package.

FIG. 2 is a perspective view of a customer using a smartphone to capture an image of the mark of FIG. 1. A shipping entity's shipping application on the mobile phone may receive the captured image of the mark and, working with a computer system of the shipping entity, may determine whether the mark is distinctive enough to uniquely identify the package, or whether the mark needs to be made more distinctive or perhaps replaced entirely with a more distinctive mark. A user interface of the phone may be used to communicate with the customer whether the mark is acceptable or needs to be replaced or modified.

After the application and computer system has determined that the mark is acceptably distinctive, the application and/or computer system may associate the mark with a shipping record. The customer may enter the data into the application to create a new shipping record, including the package's desired destination address, or the customer may select an existing shipping record and destination address that is already in the shipping company's database.

The identifying mark can be drawn by hand in various ways including by use of pens, pencils, ink permanent markers, paint, etc. The mark can also be created by using any custom sticker or otherwise unique identifying mark that is available. The shipping entity's computer system can determine if the mark is sufficiently unique to ensure reliable matching as compared to other marks currently stored in the computer system. If the mark is not sufficiently unique the system can give feedback to the customer/user and/or prompt the customer/user to add additional unique elements to the mark.

In one embodiment, the user may hand write a string of alphanumeric characters on the package, and the application and computer system may interpret this mark as the string of alphanumeric characters without characterizing the “font” or style in which the customer has written the alphanumeric characters. The string of alphanumeric characters may be randomly chosen for uniqueness by the customer, such as “sf4d56lm4” or may have meaning to the customer, such as an internally-used shipping destination number, such as “Chrysler-895”, or can be something even more descriptive, such as “Chrysler Detroit Mack Ave”.

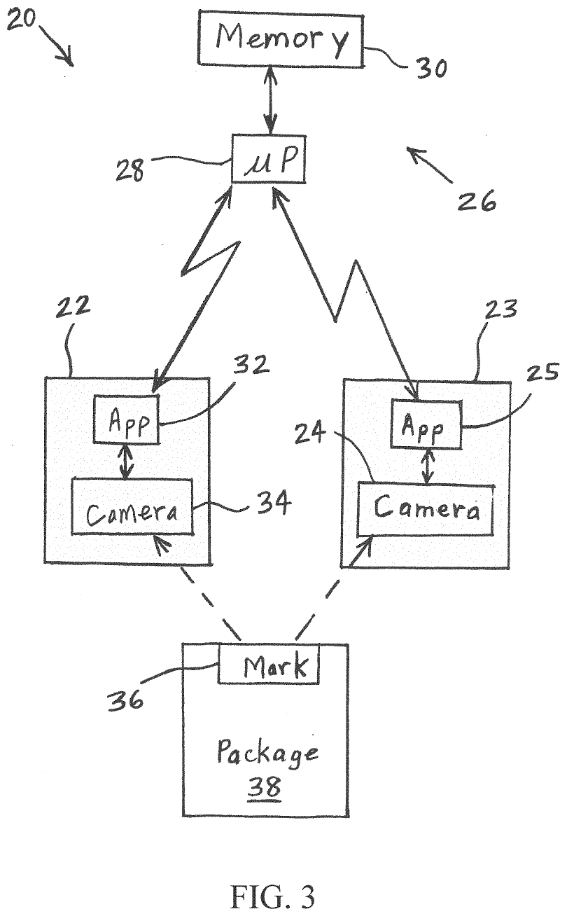

FIG. 3 illustrates one embodiment of a package shipping arrangement 20 of the present invention, including a customer's smartphone 22, a shipping entity's mobile electronic device 23, and a shipping entity's computer system 26, which is schematically indicated as having a processing block 28 and a memory block 30. Smartphone 22 includes an application 32 provided by a shipping entity, and a camera 34. Mobile electronic device 23 includes a camera 24 and an application 25.

During use, a customer hand draws a mark 36 on a package 38 that he would like to ship. After opening application 32, the customer uses camera 34 to capture a photograph of mark 36. Application 32 wirelessly forwards the photograph of mark 36 to processing block 28, which then compares the mark to photographs of other marks that are currently in use and that are stored in memory block 30. If processing block 28 determines that the mark cannot be easily distinguished from another mark stored in memory block 30, then processing block 28 causes application 32 to inform the customer that his mark is not sufficiently unique and prompt the customer to make and photograph another mark, or modify and photograph the existing mark. The new or modified mark is then re-submitted to processing block 28 to check its uniqueness, and this process may continue in an indefinite number of iterations until the customer has created and photographed a sufficiently unique mark. The application 32 then associates the unique mark with a shipping record in memory block 30, which includes a destination shipping street address. The customer may enter the full shipping record into the application via smartphone 22, or the customer may use application 32 merely to select an existing shipping record to associate with the unique mark. Application 32 then informs the customer that package 38 is ready to be picked up by an employee of the shipping entity, or is ready for the customer to take package 38 to the shipping entity's office.

Once an employee of the shipping entity receives package 38, he may use camera 24 to capture an image of mark 36 on a package 38 and create a digital representation of mark 36. Application 25 then wirelessly forwards the digital representation of mark 36 to processing block 28, and processing block 28 finds the shipping record that was previously stored in memory block 30 in association with mark 36. Based upon the shipping record, and the destination address in the shipping record in particular, the employee routes package 38 such that package 38 will be delivered to the destination address. At any point along the shipping route, any employee can recapture an image of mark 36 on package 38 in order to determine the desired destination address of package 38.

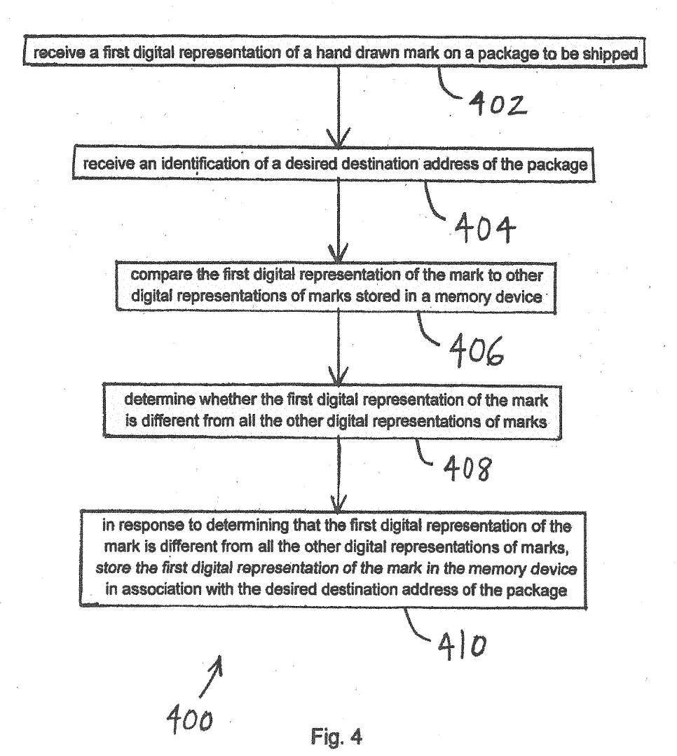

FIG. 4 is a flow chart of one embodiment of a package shipping method 400 of the present invention. In a first step 402, a first digital representation is received of a hand drawn mark on a package to be shipped. For example, a camera 34 may capture a digital representation in the form of an image of the mark 36 on the package 38. An application 32 may wirelessly forward the photograph of mark 36 to processing block 28.

Next, in step 404, an identification of a desired destination address of the package is received. For example, there may be a shipping record in memory block 30, which includes a destination shipping street address of package 38. The customer may enter the full shipping record into the application via smartphone 22, or the customer may use application 32 merely to select an existing shipping record to associate with the unique mark 36.

In a next step 406, the first digital representation of the mark is compared to other digital representations of marks stored in a memory device. For example, processing block 28 may compare photograph of mark 36 to photographs of other marks that are currently in use and that are stored in memory block 30.

In step 408, it is determined whether the first digital representation of the mark is different from all the other digital representations of marks. For example, processing block 28 may determine whether the mark can be easily distinguished from all other marks stored in memory block 30.

In a final step 410, in response to determining that the first digital representation of the mark is different from all the other digital representations of marks, the first digital representation of the mark is stored in the memory device in association with the desired destination address of the package. For example, in response to determining that the photograph of mark 36 is different from all the photographs of marks stored in memory block 30, application 32 may associates the unique mark 36 with a shipping record in memory block 30, which includes a destination shipping street address.

The invention has been described herein as using a hand drawn mark to associate a package with shipping information. However, it is to be understood that the invention may be used to associate any physical object with information stored on a computer about that object.

The foregoing detailed description is given primarily for clearness of understanding and no unnecessary limitations are to be understood therefrom for modifications can be made by those skilled in the art upon reading this disclosure and may be made without departing from the spirit of the invention. What is claimed is:

1. A package shipping arrangement comprising:
a computer system including a processing block and a memory block, the processing block being configured to:
receive a first digital representation of a hand drawn mark on a package to be shipped, the first digital representation of the mark having been captured by a camera;
receive an identification of a desired destination address of the package;
compare the first digital representation of the mark to other digital representations of marks stored in the memory block;
determine whether the first digital representation of the mark is different from all the other digital representations of marks; and
in response to determining that the first digital representation of the mark is different from all the other digital representations of marks, store the first digital representation of the mark in the memory block in association with the desired destination address of the package; and
a camera configured to capture an image of the hand drawn mark on the package to be shipped and transmit a second digital representation of the mark based on the captured image to the processing block, wherein the processing block is further configured to use the second digital representation of the mark to retrieve from the memory block the desired destination address of the package that has been stored in association with the first digital representation of the mark.

2. The package shipping arrangement of claim 1 wherein the computer system is configured to, in response to determining that the first digital representation of the mark is not different from all the other digital representations of marks, transmit a message to a smartphone of a human user, the smartphone including the camera that captured the first digital representation of the mark, the message informing the user that the mark is not unique, or prompting the user to modify the mark or provide another mark.

3. The package shipping arrangement of claim 1 wherein the processing block is configured to receive the first digital representation of the mark from a personal electronic device of a human user.

4. The package shipping arrangement of claim 1 wherein the processing block is configured to receive the identification of the desired destination address by receiving an identification of a shipping record including the desired destination address.

5. The package shipping arrangement of claim 1 wherein the processing block is configured to receive the identification of the desired destination address from a personal electronic device of a human user.

6. The package shipping arrangement of claim 1 wherein the camera is a mobile handheld device.

7. The package shipping arrangement of claim 1 wherein the hand drawn mark does not include any alphanumeric characters.

8. A package shipping method comprising:
receiving a first digital representation of a hand drawn mark on a package to be shipped;
receiving an identification of a desired destination address of the package;
comparing the first digital representation of the mark to other digital representations of marks stored in a memory device;
determining whether the first digital representation of the mark is different from all the other digital representations of marks; and
in response to determining that the first digital representation of the mark is different from all the other digital representations of marks, storing the first digital representation of the mark in the memory device in association with the desired destination address of the package.

9. The package shipping method of claim 8 further comprising:
capturing a second digital representation of the hand drawn mark on the package to be shipped; and
using the second digital representation of the hand drawn mark to retrieve from the memory device the desired destination address of the package.

10. The package shipping method of claim 9 wherein the capturing of the second digital representation of the hand drawn mark is performed by a mobile handheld camera.

11. The package shipping method of claim 8 further comprising, in response to determining that the first digital representation of the mark is not different from all the other digital representations of marks, transmitting a message to a smartphone of a human user, the smartphone including a camera that captured the first digital representation of the mark, the message informing the user that the mark is not unique, or prompting the user to modify the mark or provide another mark.

12. The package shipping method of claim 8 wherein the identification of the desired destination address is received by receiving an identification of a shipping record including the desired destination address.

13. The package shipping method of claim 8 wherein the identification of the desired destination address is received from a personal electronic device of a human customer.

14. The package shipping method of claim 8 wherein the hand drawn mark does not include any alphanumeric characters.

15. A package shipping method comprising:
receiving a first digital representation of a hand drawn mark on a package to be shipped;
receiving an identification of a desired destination address of the package;
storing the first digital representation of the mark in the memory device in association with the desired destination address of the package;
capturing a second digital representation of the hand drawn mark on the package to be shipped; and
using the second digital representation of the hand drawn mark to retrieve from the memory device the desired destination address of the package.

16. The package shipping method of claim 15 wherein the first and second digital representations of the hand drawn mark do not identify any alphanumeric characters.

17. The package shipping method of claim 15 further comprising:
comparing the first digital representation of the mark to other digital representations of marks stored in the memory device; and
determining whether the first digital representation of the mark is different from all the other digital representations of marks, wherein the storing step is performed in response to determining that the first digital representation of the mark is different from all the other digital representations of marks.

18. The package shipping method of claim 17 further comprising, in response to determining that the first digital representation of the mark is not different from all the other digital representations of marks, transmitting a message to a smartphone of a human user, the smartphone including a camera that captured the first digital representation of the mark, the message informing the user that the mark is not unique, or prompting the user to modify the mark or provide another mark.

19. The package shipping method of claim 15 wherein the capturing of the second digital representation of the hand drawn mark is performed by a mobile handheld camera.

20. The package shipping method of claim 15 wherein the identification of the desired destination address is received by receiving an identification of a shipping record including the desired destination address.

21. The package shipping method of claim 15 wherein the identification of the desired destination address is received from a personal electronic device of a human customer.
